(19) United States
(12) Patent Application Publication
(10) Pub. No.: US 2022/0147942 A1
(43) Pub. Date: May 12, 2022

(54) PROPOSAL EVALUATION SYSTEM, PROPOSAL EVALUATION DEVICE, AND PROPOSAL EVALUATION METHOD

(71) Applicant: Hitoshi Chino, Chino-shi (JP)

(72) Inventor: Hitoshi Chino, Chino-shi (JP)

(21) Appl. No.: 17/583,638

(22) Filed: Jan. 25, 2022

Related U.S. Application Data
(63) Continuation of application No. PCT/JP2020/025598, filed on Jun. 30, 2020.

(30) Foreign Application Priority Data
Jul. 25, 2019 (JP) 2019-136520

(51) Int. Cl. G06Q 10/10; G07C 13/00; H04L 9/40

(52) U.S. Cl. CPC G06Q 10/103; H04L 63/08; G07C 13/00

(57) ABSTRACT

Among three problems that occur at the time of making a proposal-based discussion online, personalization of discussion, difficulty in maintaining a healthy discussion structure and difficulty in evaluating a proposal, at least the personalization of discussion and the difficulty in evaluating a proposal are improved. A proposal evaluation device for communicating each of client terminals and via a communication network and performing authentication for each user is provided with a proposal support means and an evaluation support means. The proposal support means prompts authenticated users to submit a well-formed proposal that includes each of a belief or fact, a policy, and an association between the belief or fact and the policy as a configuration element. The evaluation support means prompts the authenticated users to perform voting for evaluation of each configuration element about a submitted well-formed proposal.

### CROSS-REFERENCE TO RELATED APPLICATIONS

This application is a Continuation application of PCT Application No. PCT/JP2020/025598, filed Jun. 30, 2020, and based upon and claiming the benefit of priority from prior Japanese Patent Application No. 2019-136520, filed Jul. 25, 2019, the entire contents of all of which are incorporated herein by reference.

### FIELD

The present disclosure relates to a proposal evaluation system, a proposal evaluation device, and a proposal evaluation method.

### BACKGROUND

As communication tools for realizing a proposal and a discussion online, a bulletin board (see, for example, Non Patent Literature 1), various kinds of SNSs (see, for example, Non Patent Literature 2), a wiki (see, for example, Non Patent Literature 3), a blog, a comment function (see, for example, Non Patent Literature 4) and the like are given.

### SUMMARY

In the case of making a discussion using an existing communication tool, however, the following problems easily occur. A first problem is a problem of personalization of discussion. Specifically, there are a problem that the quality of a discussion significantly changes depending on the discretion of a person who has proposed a topic and started the discussion (hereinafter, a discussion source user), a problem that a discussion stagnates during a period during which a discussion source user is not logged in, a problem that, because the ideology of a discussion source user is often not clear, assumptions of definitions of terms, definitions of conceptions and the like may be misunderstood, and the discussion is advanced while difference among interpretations of the proposal exists among participants in the discussion. Further, a problem that speech/negotiation techniques of a discussion source user influence acceptance/rejection of proposed content, a problem that a disputant who starts a personality attack on a discussion source user appears and a problem that it is not possible to make a straightforward discussion because of consideration of the emotion of a discussion source user are also given as adverse influences of personalization of discussion.

As a second problem, a problem that it is difficult to maintain a structure for improving proposed content is given. This is because, if there is a person who has an intention to oppose among participants in a discussion, the focus of the discussion shifts to persuading the participant in the discussion, and the discussion is transformed into a negotiation, or the discussion is stagnated. Further, there is also a problem that a discussion may be finished by many supporters though proposed content has not been sufficiently examined.

A third problem is a problem that, in the case of performing two-choice simple voting about acceptance/rejection of proposed content, voters are forced to make a comprehensive judgment (a high-level judgment in consideration of a tradeoff between merits and demerits) for the whole discussion. Further, there is also a problem that, since it is not possible to visualize partial evaluation of proposed content, improvement of the proposed content becomes difficult.

The present disclosure has been made in view of the above situation, and an object is to improve, among the three problems that occur at the time of making a proposal-based discussion online, at least the personalization of discussion and the difficulty in evaluating a proposal.

In order to solve the above problems, the present disclosure provides a proposal evaluation system including a plurality of client terminals and a proposal evaluation device for communicating with each of the plurality of client terminals via a communication network and performing authentication for each of users of the client terminals, wherein the proposal evaluation device includes: proposal support means for prompting authenticated users to submit a well-formed proposal that includes each of a belief or fact, and a policy associated with the belief or fact as a configuration element; and evaluation support means for prompting the authenticated users to perform voting for evaluation of each configuration element about a submitted well-formed proposal.

According to the present disclosure, since the topic of a discussion is submitted as a well-formed proposal, it is possible to avoid personalization of discussion. Further, according to the present disclosure, since evaluation of each configuration element of a submitted well-formed proposal is prompted, partial evaluation of proposed content can be visualized, and it becomes easy to improve the proposed content. That is, according to the present disclosure, it becomes possible to improve at least the personalization of discussion and the difficulty in evaluating a proposal among the three problems that occur at the time of making a proposal-based discussion online.

In a more favorable aspect, the proposal evaluation device further includes discussion support means for prompting the authenticated users to make a discussion for each submitted well-formed proposal. According to the present aspect, an effect is obtained that it becomes easy to maintain a structure for improving proposed content by prompting a discussion to sufficiently examine the proposed content.

In another favorable aspect, at least any one of the plurality of client terminals functions as the proposal evaluation device. According to the present aspect, an effect is obtained that it becomes unnecessary to prepare a proposal evaluation device as a device separated from the client terminals.

Further, in order to solve the above problems, the present disclosure provides a proposal evaluation device for communicating with each of a plurality of clients via a communication network and performing authentication for each of users of the client terminals, the proposal evaluation device including: proposal support means for prompting authenticated users to submit a well-formed proposal that includes each of a belief or fact, and a policy associated with the belief or fact as a configuration element; wherein the proposal evaluation device prompts the authenticated users to perform voting for evaluation of each configuration element about a submitted well-formed proposal. According to this proposal evaluation device, it also becomes possible to improve at least the personalization of discussion and the difficulty in evaluating a proposal among the three problems that occur at the time of making a proposal-based discussion online.

Further, in order to solve the above problems, the present disclosure provides a proposal evaluation method causing a proposal evaluation device for communicating with each of the plurality of client terminals via a communication network and performing authentication for each of users of the client terminals to execute the steps of: prompting authenticated users to submit a well-formed proposal that includes each of a belief or fact, and a policy associated with the belief or fact as a configuration element; and prompting the authenticated users to perform voting for evaluation of each configuration element about a submitted well-formed proposal. According to this proposal evaluation method, it also becomes possible to improve at least the personalization of discussion and the difficulty in evaluating a proposal among the three problems that occur at the time of making a proposal-based discussion online.

As another aspect of the present disclosure, an aspect of providing a program to cause a general computer such as a CPU (central processing unit) to function as the proposal support means and evaluation support means described above, that is, a program to cause the computer as the proposal evaluation device of the present disclosure is conceivable. According to this aspect, it also becomes possible to improve at least the personalization of discussion and the difficulty in evaluating a proposal among the three problems that occur at the time of making a proposal-based discussion online.

### DRAWINGS

FIG. 1 is a diagram showing a configuration example of a proposal evaluation system according to an embodiment of the present disclosure.

FIG. 2 is a diagram showing an example of a well-formed proposal.

FIG. 3 is a diagram showing an example of a user interface screen displayed on client terminals.

FIG. 4 is a diagram showing an example of a user interface screen displayed on the client terminals.

FIG. 5 is a flowchart showing a flow of proposal of a topic, discussion and evaluation in the present embodiment.

FIG. 6 is a flowchart showing a flow of a discussion at a discussion phase.

### DETAILED DESCRIPTION

An embodiment of the present disclosure will be explained with reference to drawings.

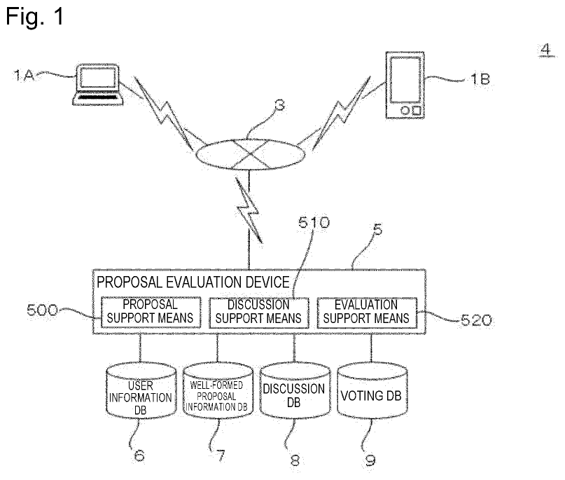

FIG. 1 is a diagram showing a configuration example of a proposal evaluation system 4 according to an embodiment of the present disclosure. As shown in FIG. 1, the proposal evaluation system 4 includes a client terminal 1A and a client terminal 1B each of which is connected to a communication network 3, and a proposal evaluation device 5 connected to the communication network 3.

The communication network 3 is, for example, the Internet. The communication network 3 intermediates data communication performed between devices connected thereto according to a predetermined communication protocol (for example, TCP/IP). Though explanation will be made on a case where the communication network 3 is the Internet in the present embodiment, the communication network 3 may be an intranet laid among business facilities of a company, and the like.

As an example of the client terminal 1A, a personal computer is given. As an example of the client terminal 1B, a smartphone or a tablet terminal is given. The client terminals 1A and 1B in the present embodiment are computers capable of executing a web browser. Hereinafter, when it is not necessary to distinguish between the client terminal 1A and the client terminal 1B, they are referred to as “client terminals 1”.

Connection of the client terminals 1 to the communication network 3 may be either wired connection or wireless connection. Though the two client terminals 1 are illustrated in FIG. 1, three or more client terminals 1 may be included in the proposal evaluation system 4. In short, it is only necessary that a plurality of client terminals are included in the proposal evaluation system 4. Since the client terminals 1 are not especially different from a general computer in which a web browser is installed, detailed explanation thereof will be omitted.

The proposal evaluation device 5 is a device for providing communication services such as proposal of a topic to be discussed, discussion of the proposed topic, voting for the discussed topic and evaluation based on a result of the voting. Users of the client terminals 1 can use the communication services provided by the proposal evaluation device 5 by having performed user registration with the proposal evaluation device 5.

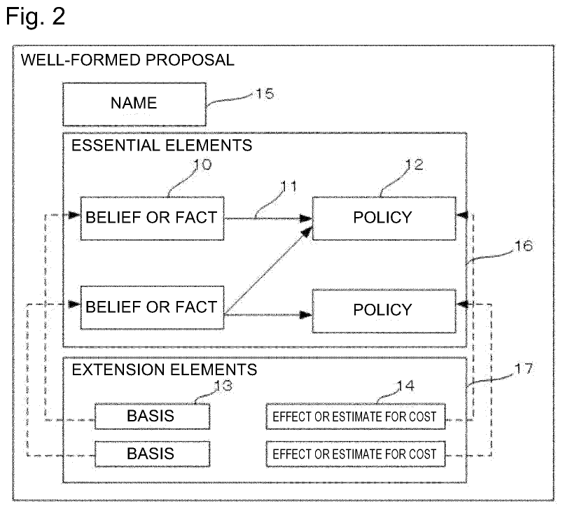

In the present embodiment, a topic to be discussed is proposed in a well-formed proposal format, and this point is one of characteristics of the present embodiment. FIG. 2 is a diagram showing a configuration of a well-formed proposal. The well-formed proposal necessarily includes essential elements 16. The well-formed proposal may further include a proposal identifier 15 for facilitating identification of the well-formed proposal and extension elements 17 as shown in FIG. 2.

The essential elements 16 include one or more sets of a belief or fact 10, a policy 12 and an association 11 showing correspondence between both. As for the correspondence relationship between the belief or fact 10 and the policy 12 is not limited to a one-to-one relationship. One belief or fact may correspond to a plurality of policies, and, on the contrary, one policy may correspond to a plurality of beliefs or facts. Each policy 12 is character information indicating specific content of a policy to be implemented (for example, a character string indicating a sentence with content of a policy). Each belief or fact 10 is character information indicating a belief and ideology of a proposer required to implement a policy 12 or a matter that the proposer insists is objective (for example, a character string indicating a sentence with content of a belief or fact). It is also possible to set character information about a belief or fact for the whole proposal as a belief or fact 10. Each association 11 is information expressly showing which policy each belief or fact is basis for, and is composed of information showing a policy and a belief or fact that are associated with each other

As specific examples of the proposal identifier 15, a character string indicating a name corresponding to proposed content of a well-formed proposal, image data indicating an icon or the like corresponding to the proposed content, voice data indicating a voice corresponding to the proposed content, a character string simply indicating a topic, and the like are given. The extension elements 17 include additional materials 13 about a basis reinforcing a belief or fact, additional materials 14 about both of positive and negative effects obtained by a policy, an estimate for costs required to implement the policy and the like, and the like. The materials 14 may include materials about a method for preparing the costs required to implement the policy.

As shown in FIG. 1, the proposal evaluation device 5 is connected to the communication network 3. A user information database (in FIG. 1, “database” is abbreviated as “DB”; and, hereinafter, the same applies to the present specification) 6, a well-formed proposal information DB 7, a discussion DB 8 and a voting DB 9 are connected to the proposal evaluation device 5. The connection between the proposal evaluation device 5 and the communication network 3 may also be either wired connection or wireless connection. Similarly, the connection between the proposal evaluation device 5 and each of the DBs may also be either wired connection or wireless connection.

Each of the user information DB 6, the well-formed proposal information DB 7, the discussion DB 8 and the voting DB 9 is, for example, made up of a storage device such as a hard disk. The user information DB 6 stores user identification information (for example, a user ID and a password) that uniquely identifies each user permitted to use the communication services provided by the proposal evaluation device 5. By causing user identification information to be stored into the user information DB 6, user registration is completed. The proposal evaluation device 5 performs authentication for users who have accessed the proposal evaluation device 5 using the client terminals 1 by referring to the content stored in the user information DB 6, the details of which will be described later. In the well-formed proposal information DB 7, pieces of well-formed proposal information showing well-formed proposals submitted by authenticated users are stored. In the discussion DB 8, pieces of discussion information showing content of discussions for the well-formed proposals shown by the pieces of well-formed proposal information stored in the well-formed proposal information DB 7 are stored for the well-formed proposals, respectively. In the voting DB 9, pieces of voting information showing content of voting by authenticated users for discussed well-formed proposals are stored for the well-formed proposals, respectively.

The proposal evaluation device 5 is, for example, a personal computer, and a program for realizing provision of the above communication services are installed in the proposal evaluation device 5 in advance. A CPU (not shown in FIG. 1) of the proposal evaluation device 5 executes the above program by being triggered by the proposal evaluation device 5 being powered on, and functions as a so-called web server. More specifically, the CPU of the proposal evaluation device 5 authenticates users who have accessed the proposal evaluation device 5 using the client terminals 1, using user identification information stored in the user information DB 6. Then, the CPU of the proposal evaluation device 5 returns data for causing a user interface (hereinafter abbreviated as “UI”) screen for prompting use of the communication services provided by the proposal evaluation device 5 to be displayed (for example, HTML (Hyper Text Markup Language) data) to the client terminals 1 of authenticated users. Each of the client terminals 1 interprets the HTML data by a web browser and displays the UI screen.

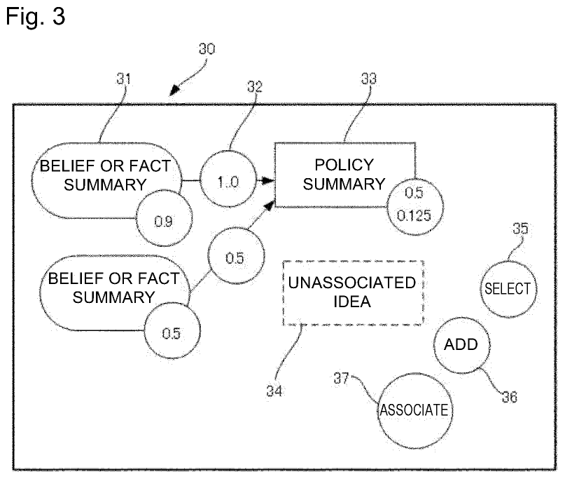

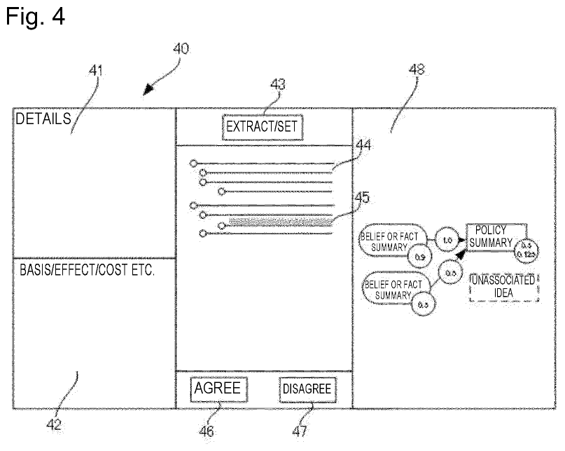

FIGS. 3 and 4 are diagrams showing examples of the UI screen displayed by the client terminals 1.

Each of the client terminals 1 which have received the HTML data displays a UI screen 30 shown in FIG. 3 first according to the HTML data. On the UI screen 30, belief or fact summaries 31 corresponding to beliefs/summaries to be included into a well-formed proposal, a policy summary 33 corresponding to a policy to be included into the well-formed proposal, and arrows corresponding to associations between the belief or fact summaries 31 and the policy summary 33.

On the UI screen 30, near each of belief or fact summaries, a policy summary and associations associating the belief or fact summaries and the policy summary, a mark in which a voting result therefor is shown is attached. In FIG. 3, a reference sign 32 is given only to a mark in which a voting result for an association associating a belief or fact summary 31 and the policy summary 33 is shown. In the present embodiment, in a mark given to a policy summary, a voting result for the policy summary itself, and an evaluation score of the whole that is determined from evaluation results for the policy summary, a belief or fact associated with the policy summary and an association associating the policy summary and the belief or fact are displayed. In the example shown in FIG. 3, the value 0.5 written at the upper part in a mark given to the policy summary is a value of a voting result for the policy summary itself, and the value 0.125 written at the lower part is an evaluation score of the whole.

Further, on the UI screen 30, virtual operators of a select 35, an add 36 and an associate 37 are provided. Basic operations on the UI screen 30 are operations of pressing the virtual operators of the select 35, the add 36 and the associate 37, respectively, by a pointing device such as a mouse. Though the virtual operators are arranged on the lower right corner side of the UI screen 30 for right-handed users on the UI screen 30 shown in FIG. 3, the arrangement of the virtual operators may be customizable for left-handed users. Further, as for the virtual operators other than the select 35 may be adapted so that only an authorized user such as a chair user can operate them.

When the add 36 is pressed on the UI screen 30, and an operation of clicking or tapping an arbitrary place on the UI screen 30 is performed, the client terminals 1 add an object 34 indicating an unassociated idea to the UI screen 30.

On the UI screen 30 where the object indicating an unassociated idea is added, when the associate 37 is pressed, and an operation of dragging from the other belief or fact summary 31 to the newly added object is performed, the client terminals 1 decide the newly added object as a new policy summary and add an association.

Further, on the UI screen 30 where the object indicating an unassociated idea is added, when the associate 37 is pressed, and an operation of dragging from the newly added object to the existing policy summary 33 is performed, the client terminals 1 decide the newly added object as a new belief or fact summary and add an association.

On the UI screen 30, when the select 35 is pressed, and an operation of double-clicking or double-tapping an object on the screen is performed, the client terminals 1 display a UI screen 40 shown in FIG. 4. The UI screen 40 is a screen for prompting each user to input and view detailed content of a belief or fact and a policy, make a proposal for discussion and evaluation of a well-formed proposal. As shown in FIG. 4, the UI screen 40 includes details panes 41 and 42, discussion/voting panes 43 to 47 and an overall view (reduced) pane 48. At the time of newly creating a well-formed proposal, each user writes details of a belief or fact and a policy in the details pane 41. If supplements such as a basis, effects, costs and the like are necessary, the user writes the content thereof in the pane 42.

Other users who are users other than a proposer of a well-formed proposal adds their opinions in the discussion tree 44, referring to the details and the overall view. Each of the other users can give a marker 45 to an opinion that he wants to refer to, by performing an operation of right clicking, long pressing or the like. Further, each of the other users can extract his own opinion or an opinion he has marked, by changing the setting of the discussion extraction (filtering) setting drop-down list 43. Each of the other users can vote by pressing any of virtual operators of an agree 46 and a disagree 47 considering each of opinions.

As described above, by causing the UI screens 30 and 40 to be displayed on the client terminals 1, it is possible to prompt users of client terminals 1 who have been authenticated, to submit a well-formed proposal, make a discussion for a submitted well-formed proposal and vote for evaluation of a submitted well-formed proposal. This means that the CPU operating according to the above program functions as proposal support means 500, discussion support means 510 and evaluation support means 520 shown in FIG. 1. The proposal support means 500 is a software module for prompting authenticated users to submit a well-formed proposal. The discussion support means 510 is a software module for prompting the authenticated users to make a discussion for submitted well-formed proposals. The evaluation support means 520 is a software module for prompting the authenticated users to evaluate submitted well-formed proposals and disclosing an evaluation result to the authenticated user. It is to be noted that, for each submitted well-formed proposal, the evaluation support means 520 prompts the authenticated users to evaluate each configuration element of the well-formed proposal, the details of which will be described later.

The above is the configuration of the proposal evaluation system 4.

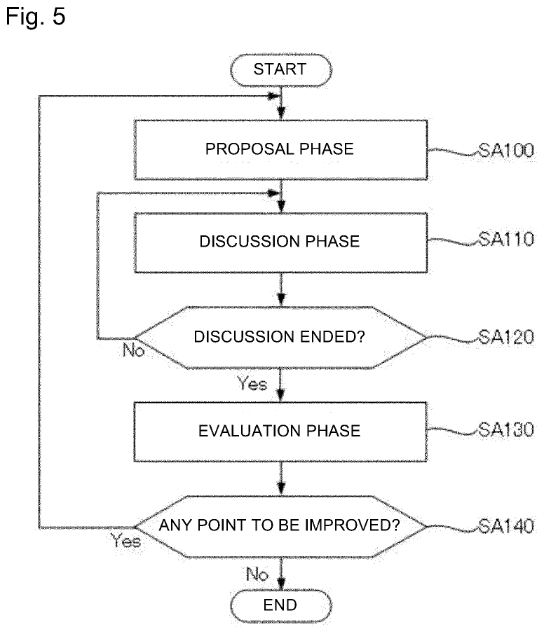

FIG. 5 is a flowchart showing a flow of proposal, discussion and evaluation of a topic in the present embodiment. At a proposal phase SA100 in FIG. 5, the CPU of the proposal evaluation device 5 functions as the proposal support means 500. That is, at the proposal phase SA100, the CPU of the proposal evaluation device 5 prompts authenticated users to submit well-formed proposals, and causes well-formed proposal information showing well-formed proposals submitted by authenticated users to be stored into the well-formed proposal information DB 7. At a discussion phase SA110 in FIG. 5, the proposal evaluation device 5 functions as the discussion support means 510. The proposal evaluation device 5 prompts the authenticated users to make discussions for the submitted well-formed proposals and causes discussion information showing content of the discussions to be stored into the discussion DB 8.

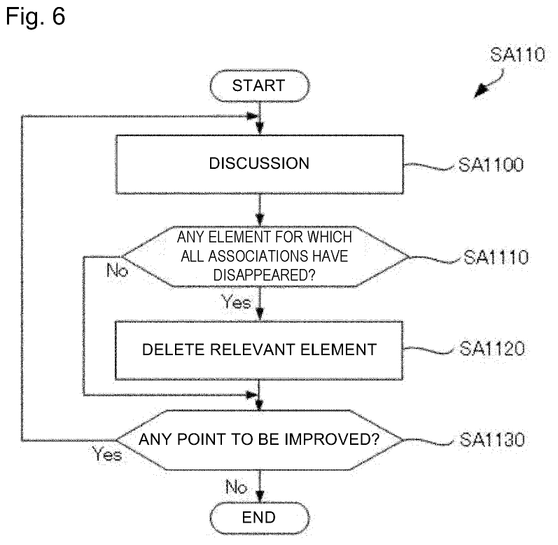

A discussion at the discussion phase SA110 is made according to a flowchart shown in FIG. 6. Authenticated users to be participants in the discussion make a discussion for a submitted well-formed proposal, paying attention to the following viewpoints (a) to (e) (step SA1100).

(a) Whether there is an ambiguous point in descriptions of a belief or fact and a policy

If there is an ambiguous point, the participants in the discussion modify the wording to resolve the ambiguous point.

(b) Whether or not there is a policy that is the same as another policy or that is a tautological policy like “to be -ed→be -ed”

If there is an applicable policy, the participants in the discussion delete the policy. This is because, in a process of modifying wording to resolve an ambiguity, it often happens that a policy becomes the same as another policy.

(c) Whether it is possible or not to disintegrate a belief or fact and a policy and incorporate disintegrated parts into another belief or fact and another policy

If it is possible, the participants in the discussion carry out the incorporation to improve easiness to understand the proposal.

(d) Whether a belief or fact associated with a policy is insufficient or not

If the belief or fact is insufficient, the participants in the discussion add a necessary belief or fact and an association with a relevant policy. At step SA1100, the participants in the discussion do not make a discussion about effectiveness of the policy.

(e) Is the association between the policy and a belief or fact logically appropriate?

If the association is not appropriate, the participants in the discussion modify the belief or fact and the policy so that the association becomes appropriate or cancel the association. It is to be noted that, at step SA1100, the participants in the discussion do not make a discussion about reliability of the belief or fact.

When a sufficient discussion is made at step SA1100, validity of the well-formed proposal being prepared (hereinafter referred to as “a degree of validity”) is improved. At step SA1100, the participants in the discussion makes a discussion only for the purpose of examining/improving the degree of validity and do not persuade an opponent or argue down a supporter.

At step SA 1110 following step SA1100, the participants in the discussion judge whether or not there is a policy that has lost an association with a belief or fact and whether or not there is a belief or fact that is not associated with any policy. If a result of the judgment of step SA1110 is “Yes”, the participants in the discussion delete a relevant element from the well-formed proposal (step SA1120) and proceed to step SA1130. If the result of the judgment of step SA1110 is “No”, the participants in the discussion proceed to step SA1130 without executing step SA1120.

At step SA1130, the participants in the discussion judge whether there is a point to be improved in the well-formed proposal, from the above viewpoints (a) to (e). If a result of the judgment is “Yes”, the participants in the discussion execute step SA1100 again. This is because a point to be improved may occur as a result of the process of step SA1120. If the result of the judgment of step SA1130 becomes “No”, the discussion at the discussion phase SA110 ends.

Returning to FIG. 5 described before, if it is judged at the discussion phase SA110 that a sufficient examination is made, or if the discussion phase SA 110 is continued until a specified period passes (while a result of the judgment of step SA120 is “No”), and the result of the judgment of step SA120 becomes “Yes”, the participants in the discussion proceed to an evaluation phase SA130. At the evaluation phase SA130, the proposal evaluation device 5 functions as the evaluation support means 520. The proposal evaluation device 5 prompts the authenticated users to perform voting for evaluation of the submitted well-formed proposal and cause a result of the voting to be stored into the voting DB 9.

At the evaluation phase SA103, for a well-formed proposal the validity degree of which has been sufficiently discussed or a well-formed proposal for which the specified discussion period has passed, each authenticated user who participates in voting makes a judgment about each of (A) reliability of beliefs or facts, (B) appropriateness of associations and (C) effectiveness of policies, and votes for or against each of the configuration elements of the well-formed proposal such as the beliefs or facts, the associations and the policies. As means for realizing the voting, online voting is representative means. However, other methods, for example, an automatic judgment by analyzing users' opinions by AI and the like are also possible. Further, a similar judgment may be made for extension elements.

For example, when voting is completed by elapse of a predetermined voting period, or the like, the proposal evaluation device 5 calculates an evaluation score V for each policy in the well-formed proposal for which the voting has been completed, by the following method. First, the proposal evaluation device 5 calculates a rate of votes obtained (the number of supporters/the number of voters) V1 for reliability of the associated belief or fact. Next, the proposal evaluation device 5 calculates a rate of votes obtained (the number of supporters/the number of voters) V2 for appropriateness of the association. Next, the proposal evaluation device 5 calculates a rate of votes obtained (the number of supporters/the number of voters) V3 for effectiveness of the policy. Then, the proposal evaluation device 5 calculates a product of V1, V2 and V3 calculated in the way described above as the evaluation score V of the policy. The rates of votes obtained V1, V2 and V3 and the evaluation score V calculated in this way are displayed in marks arranged near objects corresponding to the belief or fact and the like on the UI screen 30.

In the case of a policy having a plurality of beliefs or facts and a plurality of associations, the proposal evaluation device 5 calculates V1 described above for each of the plurality of beliefs or facts and the plurality of associations. A value obtained by multiplying V1 that is the lowest value by V2 and V3 calculated for the belief or fact for which the lowest value has been calculated and the policy becomes the evaluation score of the policy. Calculation of the rates of votes obtained can be calculation in consideration of the number of opponents. For example, the calculation of the rates of votes obtained can be defined as the number of supporters/(the number of supporters+the number of opponents). Further, it is also possible to consider the rates of votes obtained. Further, by calculating an evaluation score for each of policies included in a well-formed proposal, an evaluation score of the whole well-formed proposal may be decided by an average value or by a calculation method capable of clearly showing actual evaluation situation of the policies. In this case, a criterion for adopting a policy can be set to 0.5 (a majority) or a value decided in advance.

At step SA140 following the evaluation phase SA130, the authenticated users judge whether or not there is a point to be improved in the evaluated well-formed proposal. Until a result of the judgment of step SA140 becomes “No”, the authenticated users execute the proposal phase SA100 and the subsequent phases again.

According to the present embodiment, the following effects are obtained.

First, since proposed content and a discussion source user are separated in a well-formed proposal, it is possible to avoid an adverse influence brought about by personalization of discussion. Second, there is an effect that it becomes easy to maintain/manage a structure for improving the proposed content. This is because, since a discussion is advanced by paying attention only to improvement of the degree of validity and examination at the discussion phase SA110 according to the present embodiment, it is possible to avoid stagnation of the discussion due to persuasion of a person who has an intention to oppose. In addition, since an ideology that has been hidden in a topic is made clear by the well-formed proposal in the present embodiment, it is possible to find a proposal with a low degree of validity and prevent a discussion from being immaturely finished. Third, there is an effect that a result of voting for each configuration element of proposed content is visualized, and it becomes easy to improve the proposed content. This is because it is possible to vote for each configuration element of a proposal at the voting phase of the present embodiment. Further, since it is possible to vote for each configuration unit, a voter is not forced to make a comprehensive judgment.

As explained above, according to the present embodiment, it becomes possible to improve three problems that occur at the time of making a proposal-based discussion online, that is, personalization of discussion, difficulty in maintaining a healthy discussion structure and difficulty in evaluating a proposal.

(C: Modifications)

An embodiment of the present disclosure has been explained above. Of course, the following modifications may be added to the embodiment.

(1) In the above embodiment, display of the UI screen shown in FIG. 3 or 4 is realized by data transmitted from the proposal evaluation device 5 to the client terminals 1 and web browsers installed in the client terminals 1 in advance. However, display of the UI screen shown in FIG. 3 or 4 may be realized by a dedicated application. Further, though the proposal support means 500, the discussion support means 510 and the evaluation support means 520 are realized by software modules in the above embodiment, each of the means may be realized by a hardware module such as an ASIC.

(2) The proposal evaluation method in the above embodiment includes steps of prompting authenticated users to submit a well-formed proposal, prompting the authenticated users to make a discussion for a submitted well-formed proposal and prompting the authenticated users to perform voting for evaluation of each configuration element about the submitted well-formed proposal. However, a discussion and change of a submitted well-formed proposal may be omitted, and only an evaluation of the submitted well-formed proposal may be made. In this case, the step about discussion may be omitted. That is, the proposal evaluation method of the present disclosure only needs to include at least the steps of prompting authenticated users to submit a well-formed proposal and prompting the authenticated users to perform voting for evaluation of each configuration element about a submitted well-formed proposal. This is because at least the personalization of discussion and the difficulty in evaluating a proposal are improved. It is to be noted that, in the case of omitting the step about discussion, the discussion support means 510 may be omitted from the components of the proposal evaluation device 5.

(3) Though the client terminals 1 and the proposal evaluation device 5 are separate devices in the above embodiment, it is also possible to cause any one of the client terminal 1A and the client terminal 1B to play the role of the proposal evaluation device 5. Further, implementation by a so-called serverless network in which one or more of the user information DB 6, the well-formed proposal information DB 7, the discussion DB 8 and the voting DB 9 can be realized by a distributed ledger of a block chain or the like, and a program to access the distributed ledger is installed in each of the client terminals 1 in advance.

(4) In the above embodiment, the program for causing the CPU of the proposal evaluation device 5 to function as the proposal support means 500, the discussion support means 510 and the evaluation support means 520 are installed in the proposal evaluation device 5 in advance. However, a program for causing a general computer such as a CPU to function as the proposal support means 500, the discussion support means 510 and the evaluation support means 520, or as the proposal support means 500 and the evaluation support means 520 may be manufactured as a single unit and provided with or without being paid for. This is because, by causing a general computer to operate according to such a program, it becomes possible to cause the computer to function as the proposal evaluation device of the present disclosure. It is to be noted that, as specific aspects of providing the above program, an aspect of writing the above program to computer-readable recording media such as CD-ROMs (compact disk read-only memories) or flash ROMs (read-only memories) and distributing the CD-ROMs or the flash ROMs, an aspect of distributing the above program by downloading via a telecommunication line such as the Internet, and the like are conceivable.

What is claimed is:

1. A proposal evaluation system comprising a plurality of client terminals and
a proposal evaluation device for communicating with each of the plurality of client terminals via a communication network and performing authentication for each of users of the client terminals, wherein the proposal evaluation device comprises:
proposal support means for prompting authenticated users to submit a well-formed proposal that includes each of a belief or fact, a policy, and an association between the belief or fact and the policy as a configuration element; and
evaluation support means for prompting the authenticated users to perform voting for evaluation of each configuration element about a submitted well-formed proposal.

2. The proposal evaluation system according to claim 1, wherein the proposal evaluation device further comprises discussion support means for prompting the authenticated users to make a discussion for each submitted well-formed proposal.

3. The proposal evaluation system according to claim 1, wherein at least any one of the plurality of client terminals functions as the proposal evaluation device.

4. The proposal evaluation system according to claim 2, wherein at least any one of the plurality of client terminals functions as the proposal evaluation device.

5. A proposal evaluation device for communicating with each of a plurality of client terminals via a communication network and performing authentication for each of users of the client terminals, the proposal evaluation device comprising:
proposal support means for prompting authenticated users to submit a well-formed proposal that includes each of a belief or fact, a policy, and an association between the belief or fact and the policy as a configuration element; and
evaluation support means for prompting the authenticated users to perform voting for evaluation of each configuration element about a submitted well-formed proposal.

6. A proposal evaluation method causing a proposal evaluation device for communicating with each of a plurality of client terminals via a communication network and performing authentication for each of users of the client terminals to execute the steps of:
prompting authenticated users to submit a well-formed proposal that includes each of a belief or fact, a policy, and an association between the belief or fact and the policy as a configuration element; and
prompting the authenticated users to perform voting for evaluation of each configuration element about a submitted well-formed proposal.
